(19) United States
(12) Patent Application Publication
(10) Pub. No.: US 2018/0354531 A1
(43) Pub. Date: Dec. 13, 2018

(54) CONTAINER CATCHER

(71) Applicant: Trinity Rail Group, LLC, Dallas, TX (US)

(72) Inventors: Anand Prabhakaran, Chicago, IL (US); David C. Brabb, Westmont, IL (US); Robert S. Trent, Willow Springs, IL (US)

(21) Appl. No.: 16/005,883

(22) Filed: Jun. 12, 2018

Related U.S. Application Data
(60) Provisional application No. 62/518,357, filed on Jun. 12, 2017.

(51) Int. Cl. B61D 45/00; B61F 1/14; B61D 3/20; B61F 1/12

(52) U.S. Cl. CPC B61D 45/007; B61F 1/14; B60L 2200/26; B61F 1/12; B61D 3/20

(57) ABSTRACT

A railcar includes a first panel, a second panel, and a bottom surface. The second side panel opposes the first side panel and is substantially parallel to the first side panel. The bottom surface includes a first beam and a second beam. The first beam is coupled to the first side panel and the second side panel. The first beam is substantially parallel to a normal of the first side panel and to a normal of the second side panel. The second beam is coupled to the first side panel and the second side panel such that the second beam is adjacent to the first beam and such that the second beam forms less than a ninety-degree angle with the first beam. the first beam and the second beam define an open space in the bottom surface.

### CROSS REFERENCE TO RELATED APPLICATIONS

This application claims the benefit of U.S. Provisional Application Ser. No. 62/518,357, entitled “Container Catcher,” which was filed Jun. 12, 2017, having common inventorship, the entire contents of which are incorporated herein by reference.

### TECHNICAL FIELD

This disclosure relates generally to configuring a railroad freight car (also referred to as a “railcar”).

### BACKGROUND

Railcars are configured to store and transport freight across long distances. In some instances, the freight is placed in freight containers that may be defective and break during transport.

### SUMMARY

Railcars are configured to store and transport freight across long distances. For example, railcars may store or transport automobiles, military equipment, livestock, construction equipment, etc. A well car is a type of railcar used to transport freight. In some instances, the freight is loaded into freight containers that are then loaded into well cars. These containers may be defective and/or may break, causing the freight within to fall out. Existing well structures include a bottom surface that catches the freight before it falls onto the tracks below the well car. These bottom surfaces are sometimes referred to as “container catchers”. The bottom surface may include a structure where beams are crossed with each other across the bottom surface. For example, the beams may form a pattern of ‘X’-shaped structures across the bottom surface. However, the ‘X’-shaped structure uses many heavy beams which increase the weight of the well car. Existing railcar designs have incorporated various structural shapes for the container catcher, including plates, tubes, angles, and bars. Also, their attachment to the rest of the structure has varied from welding to mechanical fastening. However, these designs may be heavy as well.

This disclosure contemplates an improved design for the bottom surface that may use fewer members and thus reduces the weight of the well car relative to existing well cars that use the other heavy structures across the bottom surface. The improved design uses corrugated plates arranged in a Pratt-truss shaped structure across the bottom surface. This design reduces the weight of the bottom surface and the well car, which allows the well car to carry more freight without exceeding weight restrictions imposed by law or specifications. Additionally, this design also allows the beams to transfer forces laterally across the well car. Certain embodiments are described below.

According to an embodiment, a railcar includes a first panel, a second panel, and a bottom surface. The second side panel opposes the first side panel and is substantially parallel to the first side panel. The bottom surface includes a first beam and a second beam. The first beam is coupled to the first side panel and the second side panel. The first beam is substantially parallel to a normal of the first side panel and to a normal of the second side panel. The second beam is coupled to the first side panel and the second side panel such that the second beam is adjacent to the first beam and such that the second beam forms less than a ninety-degree angle with the first beam. the first beam and the second beam define an open space in the bottom surface.

According to another embodiment, a method includes coupling a first beam to a first side panel and a second side panel of a railcar. The second side panel opposing the first side panel and substantially parallel to the first side panel. The first beam substantially parallel to a normal of the first side panel and to a normal of the second side panel. The method also includes coupling a second beam to the first side panel and the second side panel such that the second beam is adjacent to the first beam and such that the second beam forms less than a ninety-degree angle with the first beam. The first beam and the second beam define an open space in a bottom surface of the railcar.

According to yet another embodiment, a well car includes a first side panel, a second side panel, and a bottom surface. The second side panel opposes the first side panel and is substantially parallel to the first side panel. The bottom surface includes a first beam and a second beam. The first beam is coupled to the first side panel and the second side panel. The first beam is substantially parallel to a normal of the first side panel and to a normal of the second side panel. The second beam is coupled to the first side panel and the second side panel such that the second beam is adjacent to the first beam and such that the second beam forms less than a ninety-degree angle with the first beam. The first beam and the second beam define an open space in the bottom surface.

Certain embodiments may provide one or more technical advantages. In some embodiments, the design allows for lighter gage material to be used in a manner that allows good coverage to prevent lading or container parts from falling through per specifications. Also, by corrugating the thin gage sheets the necessary strength is achieved to meet specifications. Additionally, the structure is integrated into the side sill and cross members of the car in a manner that allows the container catcher to participate in the load sharing between the two sides of the freight car, allowing for better efficiency. The design is relatively light weight in comparison with other designs and the container catcher system is mechanically fastened to the structure for easy replacement. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example well car;

FIG. 2A illustrates an example container catcher of an example well car;

FIG. 2B illustrates an example container catcher of an example well car;

FIG. 2C illustrates an example container catcher of an example well car; and

FIG. 3 is a flowchart illustrating a method of reinforcing a well car.

### DETAILED DESCRIPTION

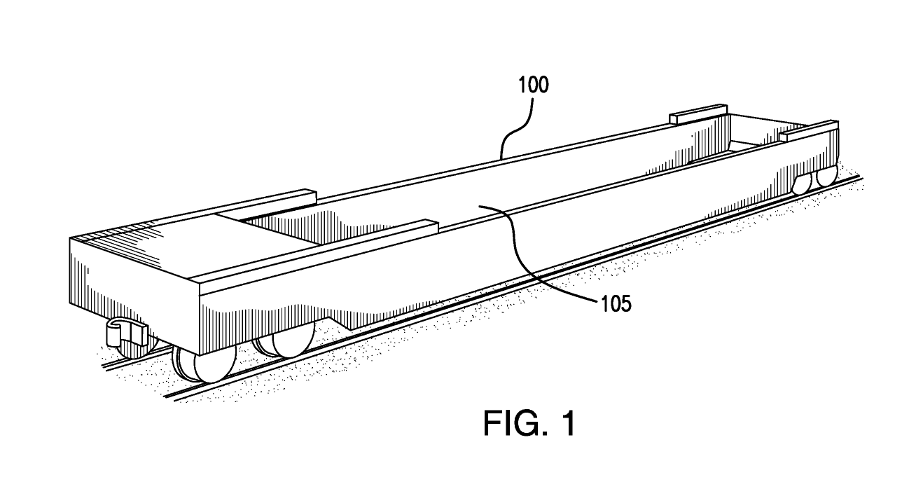

Railcars are configured to store and transport freight across long distances. For example, railcars may store or transport automobiles, military equipment, livestock, construction equipment, etc. This disclosure contemplates a railcar that is configured to store any type of freight. A well car is a type of railcar. A well car includes a well that is used to carry freight. FIG. 1A illustrates an example well car 100. Well car 100 includes a well structure 105 that is used to hold freight. Well structure 105 has side walls that are used as major structures to hold the car body together and prevent freight from falling out of well car 100 while it travels down rails. This disclosure contemplates well car 100 including any number of well structures 105. The longer well car 100 is, the more well structures 105 it may have. Well car 100 may be any suitable well car 100, such as for example, a 53′ standalone, a 53′ 3-unit, a 40′ standalone, a 40′ 5-unit, or other sizes and number of unit combinations.

In some instances, the freight is loaded into freight containers that are then loaded into well cars. These containers may be defective and/or may break, causing the freight within to fall out. Existing well structures include a bottom surface that catches the freight before it falls onto the tracks below the well car. These bottom surfaces are sometimes referred to as “container catchers”. The bottom surface may include a structure where beams are crossed with each other across the bottom surface. For example, the beams may form a pattern of ‘X’-shaped structures across the bottom surface. However, the ‘X’-shaped structure uses many heavy beams which increase the weight of the well car. Existing railcar designs have incorporated various structural shapes for the container catcher, including plates, tubes, angles, and bars. Also, their attachment to the rest of the structure has varied from welding to mechanical fastening. However, these designs may be heavy as well.

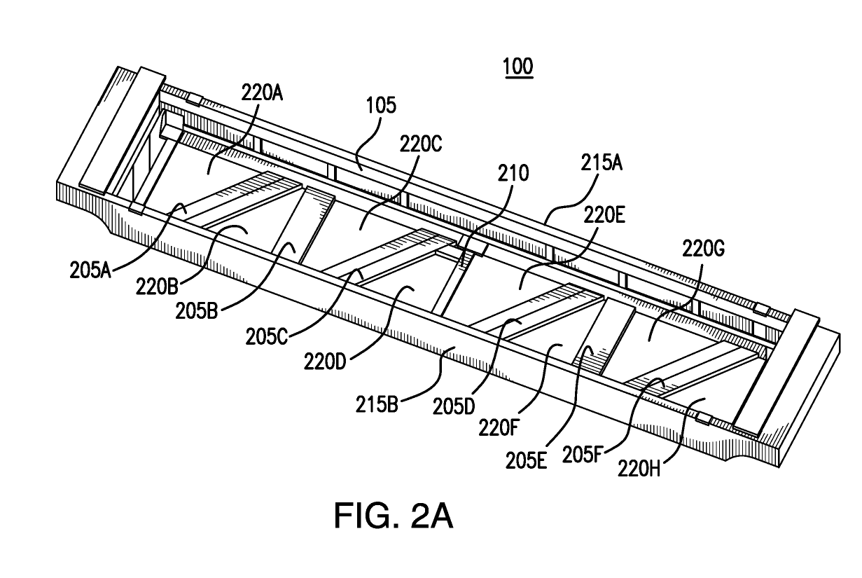

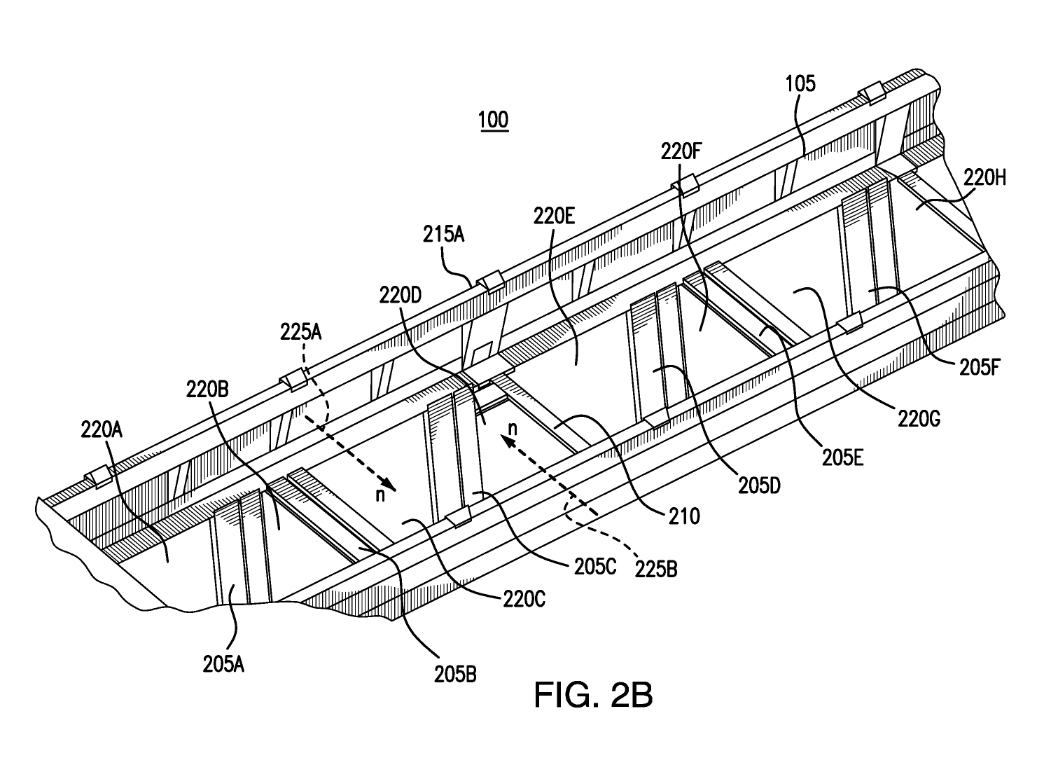

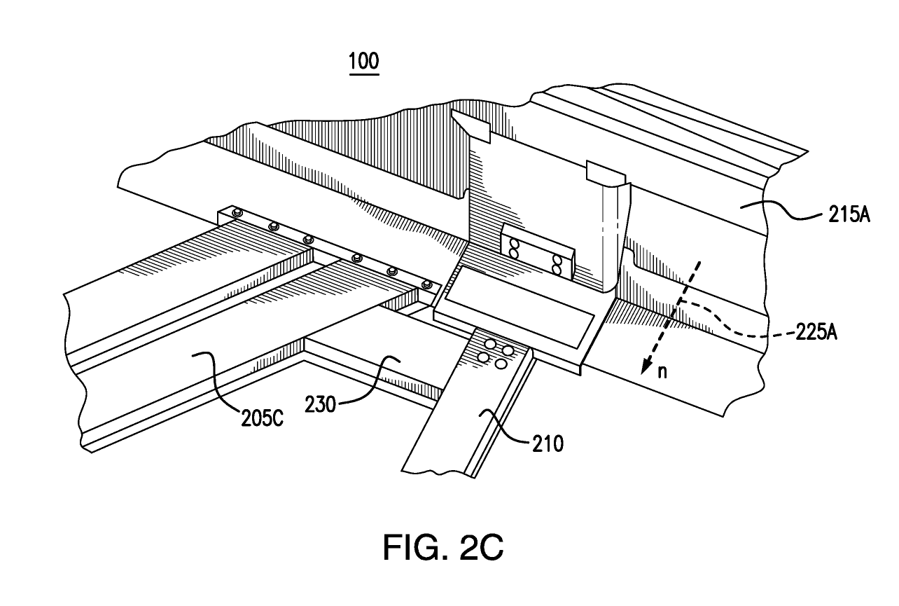

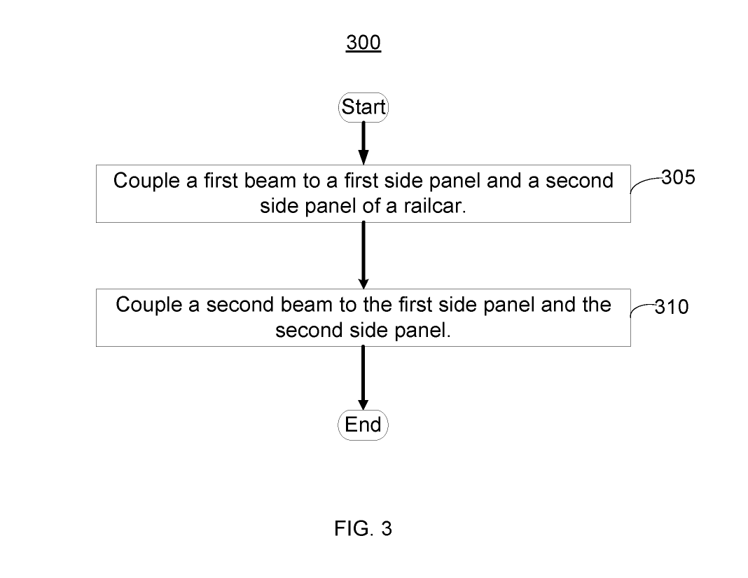

This disclosure contemplates an improved design for the bottom surface that may use fewer members and thus reduces the weight of well car 100 relative to existing well cars that use the other heavy structures across the bottom surface. The improved design uses corrugated plates arranged in a Pratt-truss shaped structure across the bottom surface. This design reduces the weight of the bottom surface and well car 100, which allows well car 100 to carry more freight without exceeding weight restrictions imposed by laws or specifications. Additionally, this design also allows the beams to transfer forces laterally across well car 100. The improved container catcher/cross-member design will be described in more detail using FIGS. 2 through 3. Although this disclosure describes the improved design being implemented on a well car, it is contemplated that the improved design can be implemented on any type of railcar. This disclosure is not limited to well cars.

In some embodiments, the design allows for lighter gage material to be used in a manner that allows good coverage to prevent lading or container parts from falling through per specifications. Also, by corrugating the thin gage sheets the necessary strength is achieved to meet specifications. Additionally, the structure is integrated into the side sill and cross members of the car in a manner that allows the container catcher to participate in the load sharing between the two sides of the freight car, allowing for better efficiency. The design is relatively light weight in comparison with other designs and the container catcher system is mechanically fastened to the structure for easy replacement. By using a corrugated cross-section for individual cross-members in s truss configuration, the weight, clearance height, and strength requirements can be optimized in some embodiments. For example, the lightest weight that will meet strength and deflection requirements is typically desired, but the beams that form the container catcher should fit between the bottom of the railcar and the container being transported.

FIGS. 2A, 2B, and 2C illustrate an example container catcher of an example well car 100. Generally, as seen in the examples of FIGS. 2A, 2B, and 2C, the bottom surface of well car 100 and well structure 105 includes several corrugated beams 205 arranged in a triangular or A-frame shape across the bottom surface. In some embodiments, the A-frame or Pratt-truss shape reduces the weight of the bottom surface and well car 100 relative to other well cars that use other container catcher designs. Each beam may be corrugated (e.g., include ridges and grooves across the length of the beam), which further reduces the weight of the overall structure and improves its strength. Furthermore, the design transfers forces laterally across well car 100. The cavities and/or holes defined by the beams are small enough and meet specifications to catch freight before it falls onto the tracks below well car 100. This disclosure contemplates the bottom surface or structure of the container catcher including any number of beams.

FIG. 2A illustrates an example container catcher of an example well car 100. As seen in FIG. 2A, well structure 105 includes side panels 215A and 215B. These side panels 215A and 215B oppose and/or face each other and form the side surfaces of well structure 105. Side panels 215A and 215B are substantially parallel with one another. Generally, side panels 215A and 215B hold freight and containers within well structure 105 as railcar 100 transports the freight and containers. This disclosure contemplates side panels 215A and 215B being any suitable height to secure freight and containers within well structure 105.

As seen in FIG. 2A, the bottom surface of well structure 105 is open. Thus, if a container in well structure 105 breaks during transport, the items within the broken container may fall out and down onto the tracks through the opening in the bottom surface. To prevent these items from falling through the bottom surface, well structure 105 includes a beam structure in the bottom surface that prevents certain items from falling through to the tracks below well car 100. This beam structure includes several beams 205A-H. This disclosure contemplates well car 100 including any appropriate number of beams to accommodate the length of well car 100.

In the example of FIG. 2A, well structure 105 includes beams 205A-H. Each beam 205 is arranged in the plane of the bottom surface of well structure 105. Each beam 205 is coupled to side panels 215A and 215B such that each beam 205 spans the width of the bottom surface. Some beams (e.g., beams 205A, 205C, 205D, and 205F) are arranged in a slanted manner and some beams (e.g., beams 205B and 205E) are arranged in a straight manner. The beams 205 are typically arranged in pairs such that a slanted beam is positioned adjacent to a straight beam. For example, beam 205A is positioned adjacent to beam 205B and beam 205D is positioned adjacent to beam 205E. Thus, the beams 205 form A-frames across the length of the bottom surface. These A-frames prevent freight from falling through the bottom surface of well structure 105 when in transport.

This disclosure contemplates beams 205 being made of any suitable material(s) (e.g., steel, aluminum, composites, etc.). It is not necessarily the case that beams 205 are all made of the same material. Although illustrated as rectangular shapes, beams 205 may be any shape (e.g., circular tubes, rectangular tubes, channels, angles, curved, etc.). Additionally, beams 205 need not be all of the same shape. Additionally, the size of individual beams 205 may vary to suit the particular designs of well structure 105. Beams 205 need not be of the same size. In some embodiments, beams 205 are corrugated. The number of corrugations may be varied. The beam 205 may include of one, two or more corrugations. The size of the corrugations may be various. A beam 205 may include corrugations all of the same size and shape or include any number of different sizes of corrugation. The shape of the corrugations may be varied, such as curved, rectangular, etc. Further, more than one shape may be used in a beam 205 at one time. The beam shape may include flanges for strength purposes, or for the purpose of connecting the beam 205 to other structure or components. In some embodiments, the diagonal/slanted beams 205 are directly connected to the bottom flange of the sill of the structure, and not to the transverse members.

In some embodiments, beams 205 may be coupled to side panels 215A and 215B by welds. In other embodiments, beams 205 may be coupled to side panels 215A and 215B by mechanical fasteners that allow one or more beams 205 to be easily decoupled from side panels 215A and 215B. In this manner, it is easier to maintain and replace beams 205 (e.g., when beams 205 are damaged).

Beams 205 may be attached to other structures via directly through the use of mechanical fasteners or by welding. Another method of attachment includes attaching the beam 205 to a structural piece that is then attached to the rest of the structure via mechanical fastening. This permits any damaged beams 205 to be easily replaced. It also allows the beams 205 to be changed to different beams 205 to facilitate changing structural requirements. In this example, a corrugated shape is attached to an angle or a z-shaped member that is subsequently mechanically fastened to the well car structure.

Well structure 105 also includes a cross member 210 that spans the width of the bottom surface of well structure 105. Cross member 210 may be positioned along a midline of side panels 215A and 215B. Cross member 210 is fastened to side panels 215A and 215B and provides structural support for well structure 105 in certain embodiments. In the illustrated example of FIG. 2A, beam 205C is positioned adjacent to cross member 210 such that beam 205C and cross member 210 form an A-frame structure that prevents freight from falling through the bottom surface of well structure 105.

As seen in FIG. 2A, the beams 205 do not cover the entire opening of the bottom surface. Beam 205A defines an open space 220A. Beams 205A and 205B define an open space 220B between the two beams 205A and 205B. Beams 205B and 205C define an open space 220C between beams 205B and 205C. Beams 205C and cross member 210 define an open space 220D. Cross member 210 and beam 205D define an open space 220E. Beam 205D and beam 205E define an open space 220F. Beam 205E and beam 205F define an open space 220G. Beam 205F defines an open space 220H. Each of the open spaces 220A-H may be sufficiently small that freight does not fall through these open spaces 220A-H.

FIG. 2B illustrates an example container catcher of well car 100. As seen in FIG. 2B, each beam 205 is arranged relative to a normal 225A of side panel 215A and a normal 225B of side panel 215B. Beams 205B and 205E are arranged parallel to normals 225A and 225B. Beams 205A, 205C, 205D, and 205F are arranged slanted relative to normals 225A and 225B. In this manner, beams 205A and 205B form less than a ninety-degree angle with each other. Similarly, beams 205D and 205E form less than a ninety-degree angle with each other. Cross member 210 is also positioned parallel to normals 25A and 225B. Thus, beam 205C and cross member 210 form less than a ninety-degree angle with each other.

FIG. 2C illustrates an example container catcher of well car 100. As seen in FIG. 2C, beam 205C is coupled to cross member 210 by beam 230. Beam 230 is arranged such that it is orthogonal to cross member 210 and to normal 225A of side panel 215A. Although not illustrated, beam 230 may also be orthogonal to normal 225B of side panel 215B. In certain embodiments, beam 230 provides additional structural support to well structure 105 of well car 100.

FIG. 3 is a flowchart of an example method 300 for reinforcing a well car. The method includes coupling a first beam to a first side panel and a second side panel of a railcar in step 305. The second side panel opposes the first side panel and is substantially parallel to the first side panel. The first beam is substantially parallel to a normal of the first side panel and to a normal of the second side panel. The method also includes coupling a second beam to the first side panel and the second side panel such that the second beam is adjacent to the first beam and such that the second beam forms less than a ninety-degree angle with the first beam in step 310. The first beam and the second beam define an open space in a bottom surface of the railcar. In some embodiments, this open space is small enough such that freight does not fall through the open space. Additionally, the design of the first beam and the second beam reduce the weight of the railcar.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A railcar comprising:
a first side panel;
a second side panel opposing the first side panel and substantially parallel to the first side panel; and
a bottom surface comprising:
a first beam coupled to the first side panel and the second side panel, the first beam substantially parallel to a normal of the first side panel and to a normal of the second side panel; and
a second beam coupled to the first side panel and the second side panel such that the second beam is adjacent to the first beam and such that the second beam forms less than a ninety-degree angle with the first beam, the first beam and the second beam define an open space in the bottom surface.

2. The railcar of claim 1, wherein the bottom surface further comprises a cross member coupled to the first side panel and the second side panel such that the cross member is parallel to the normal of the first side panel and the normal of the second side panel, the cross member positioned along a midline of the first side panel and a midline of the second side panel, the cross member and the second beam define an open space in the bottom surface.

3. The railcar of claim 2, wherein the bottom surface further comprises a third beam coupled to the first side panel and the second side panel such that the third beam is adjacent to the cross member and such that the third beam forms less than a ninety-degree angle with the cross member, the third beam and the cross member define an open space in the bottom surface.

4. The railcar of claim 3, wherein the third beam is coupled to the cross member by a fourth beam, the fourth beam is orthogonal to the cross member.

5. The railcar of claim 1, wherein the first beam and the second beam comprise at least one of steel and aluminum.

6. The railcar of claim 1, wherein the first beam is a different shape than the second beam.

7. The railcar of claim 1, wherein the first beam is coupled to the first side panel by a mechanical fastener that can decouple from the first side panel.

8. A method comprising:
coupling a first beam to a first side panel and a second side panel of a railcar, the second side panel opposing the first side panel and substantially parallel to the first side panel, the first beam substantially parallel to a normal of the first side panel and to a normal of the second side panel; and
coupling a second beam to the first side panel and the second side panel such that the second beam is adjacent to the first beam and such that the second beam forms less than a ninety-degree angle with the first beam, the first beam and the second beam define an open space in a bottom surface of the railcar.

9. The method of claim 8, further comprising coupling a cross member to the first side panel and the second side panel such that the cross member is parallel to the normal of the first side panel and the normal of the second side panel, the cross member positioned along a midline of the first side panel and a midline of the second side panel, the cross member and the second beam define an open space in the bottom surface of the railcar.

10. The method of claim 9, further comprising coupling a third beam to the first side panel and the second side panel such that the third beam is adjacent to the cross member and such that the third beam forms less than a ninety-degree angle with the cross member, the third beam and the cross member define an open space in the bottom surface.

11. The method of claim 10, wherein the third beam is coupled to the cross member by a fourth beam, the fourth beam is orthogonal to the cross member.

12. The method of claim 8, wherein the first beam and the second beam comprise at least one of steel and aluminum.

13. The method of claim 8, wherein the first beam is a different shape than the second beam.

14. The method of claim 8, wherein the first beam is coupled to the first side panel by a mechanical fastener that can decouple from the first side panel.

15. A well car comprising:
a first side panel;
a second side panel opposing the first side panel and substantially parallel to the first side panel; and
a bottom surface comprising:
a first beam coupled to the first side panel and the second side panel, the first beam substantially parallel to a normal of the first side panel and to a normal of the second side panel; and
a second beam coupled to the first side panel and the second side panel such that the second beam is adjacent to the first beam and such that the second beam forms less than a ninety-degree angle with the first beam, the first beam and the second beam define an open space in the bottom surface.

16. The well car of claim 15, wherein the bottom surface further comprises a cross member coupled to the first side panel and the second side panel such that the cross member is parallel to the normal of the first side panel and the normal of the second side panel, the cross member positioned along a midline of the first side panel and a midline of the second side panel, the cross member and the second beam define an open space in the bottom surface.

17. The well car of claim 16, wherein the bottom surface further comprises a third beam coupled to the first side panel and the second side panel such that the third beam is adjacent to the cross member and such that the third beam forms less than a ninety-degree angle with the cross member, the third beam and the cross member define an open space in the bottom surface.

18. The well car of claim 17, wherein the third beam is coupled to the cross member by a fourth beam, the fourth beam is orthogonal to the cross member.

19. The well car of claim 15, wherein the first beam is a different shape than the second beam.

20. The well car of claim 15, wherein the first beam is coupled to the first side panel by a mechanical fastener that can decouple from the first side panel.
